(19) United States
(12) Patent Application Publication
(10) Pub. No.: US 2014/0369347 A1
(43) Pub. Date: Dec. 18, 2014

(54) INCREASING RADIXES OF DIGITAL DATA SWITCHES, COMMUNICATIONS SWITCHES, AND RELATED COMPONENTS AND METHODS

(71) Applicant: Corning Cable Systems LLC, Hickory, NC (US)

(72) Inventor: Timothy James Orsley, San Jose, CA (US)

(21) Appl. No.: 13/920,326

(22) Filed: Jun. 18, 2013

(51) Int. Cl. H04L 12/947

(52) U.S. Cl. CPC H04L 49/25
USPC 370/358; 370/386

(57) ABSTRACT

Embodiments of the disclosure relate to increasing radixes of digital data switches and communications switches, and related components and methods. In one embodiment, a gearbox transfers a plurality of high bandwidth signals between a communications switch and a plurality of devices. The gearbox is configured to combine one or more groups of uplink component signals into one or more respective uplink combined signals, and transmit each combined signal to the communications switch. Each uplink component signal is combined into only one of the at least one respective downlink combined signal to ensure that no individual uplink component signal is divided between multiple uplink combined signals, thereby simplifying the process of combining the uplink component signals and dividing the uplink combined signals. The communications switch is then configured to divide each uplink combined signal back into its respective uplink component signals.

### BACKGROUND

The technology of the disclosure relates to data transfers between and among digital data switches, servers, and other devices, and related components, devices, systems, and methods. The disclosure relates generally to data transfers between and among digital data switches, servers, and other devices, and more particularly to increasing radixes of digital data switches, communications switches, and related components and methods, which may be used in data centers and other data transfer applications.

As demand for network services increases, high density digital data switches are being used at an increasing rate. One application for digital data switches is in a data center or other installation where a large amount of data must be transferred among devices. High density switches, such as “top-of-rack” switches, help to decrease the number of “layers” in a network. This arrangement allows data to be transferred between devices while passing through a minimum number of intermediary switches and other devices.

Conventional switches can employ passive breakout cable assemblies each connected between a single high bandwidth port and a plurality of lower bandwidth ports. In this regard, FIG. 1 illustrates a commonly used breakout cable assembly 10. The breakout cable assembly 10 is a passive copper-based cable assembly. The breakout cable assembly 10 is capable of transferring up to four (4) ten gigabit (10 G) signals using the widely known Ethernet protocol. The breakout cable assembly 10 transfers the 10 G signals from a single quad small form-factor port (QSFP) connector 12 to each of four small form-factor (SFP+) connectors 14 via a respective copper-based cable 16. Generally speaking, the copper based cable assemblies are length limited due to bandwidth constraints such as limited to about to seven (7) meters long in this example. Because the conventional breakout cable assembly 10 in FIG.1 contains no active circuitry, the manufacturing and maintenance cost of the breakout cable assembly 10 is relatively low compared to cable assemblies having active connections, such as optical-fiber based connections (e.g., active cable assemblies). Thus, the breakout cable assembly 10 can be very cost effective for certain lower-density applications. However, because of the limitations of copper-based cable assembly, the breakout cable assembly 10 in this example is limited to, at most, four (4) 10 G SFP+ connections.

However, as the number of devices, such as servers, served by a switch increases, the limitations of the breakout cable assembly 10 become apparent. Many conventional servers are operated with 10 G connections, such as a main SFP+ connection and a backup SFP+ connection connected to a separate, redundant switch. However, because each conventional breakout cable assembly 10 of FIG. 1 is not designed to support more than four (4) 10 G SFP+ connections, a given switch is therefore limited to a maximum of four (4) times the number of QSFP connections supported by each switch in this example. Because each switch can only support a certain number of QSFP connections due to space constraints, there is a need to increase the number of devices that can be connected to the switch (i.e., increasing the radix of the switch or other device).

### SUMMARY

Embodiments of the disclosure relate to increasing radixes of digital data switches and communications switches, and related components and methods. In one embodiment, a gearbox distributes a plurality of high bandwidth digital data signals from a digital data switch to a plurality of devices. A gearbox can be a device or component that combines, divides, converts or otherwise modifies one or more communications or other signals for distribution. The digital data switch is configured to combine one or more groups of downlink component digital data signals into one or more respective downlink combined digital data signals, and transmit each combined digital data signal to the gearbox. Each downlink component digital data signal is combined into only one of the at least one respective downlink combined digital data signal. Thus, no individual component digital data signal is divided between multiple downlink combined digital data signals, thereby simplifying the process of combining the downlink component digital data signals and dividing the downlink combined digital data signals. The gearbox is then configured to divide each downlink digital data signal into its respective downlink component digital data signal, and transmit each downlink component digital data signal to a unique device or location. As a non-limiting example, each of a plurality of pairs of 10 gigabit (10 G) downlink component digital data signals is combined into a respective 20 G combined digital data signal. Each 20 G combined digital data signal comprises interleaved sections of each of the respective pair of 10 G downlink component digital data signals that can be easily synchronized to a clock signal. The gearbox can then divide each 20 G combined digital data signal into the pair of 10 G downlink component digital data signals and transmit each 10 G downlink component digital data signal to a unique device or location. In this manner, digital data switches can be designed employing embodiments disclosed herein to support increased numbers of devices and/or bandwidths within conventional form factors. One advantage of this arrangement is that the switch radix is doubled while maintaining backward compatibility with existing ports and connectors.

One embodiment of the disclosure relates to a gearbox for a communications system. The gearbox comprises a plurality of server-side inputs, each configured to receive a respective uplink component communications signal from a respective location. The gearbox further comprises at least one multiplexer configured to combine at least two of the uplink component communications signals into at least one respective uplink combined communications signal such that each uplink component communications signal is combined into only one of the at least one respective uplink combined communications signal. The gearbox further comprises at least one switch-side output configured to transmit a respective uplink combined communications signal to a communications switch. In this manner, a radix of the communication switch can be increased in a simplified and efficient manner.

An additional embodiment of the disclosure relates to a communications switch. The communications switch comprises at least one input configured to receive a respective uplink combined communications signal comprising a plurality of uplink component communications signals from a gearbox, each uplink component communications signal corresponding to a unique location. The communications switch further comprises at least one demultiplexer configured to divide each of the at least one uplink combined communications signal into the respective plurality of uplink component communications signals.

An additional embodiment of the disclosure relates to a method of transferring communications signals. The method comprises receiving, at a gearbox, a plurality of uplink component communications signals. The method further comprises combining, at the gearbox, at least two of the uplink component communications signals into at least one respective uplink combined communications signal such that each uplink component communications signal is combined into only one of the at least one respective uplink combined communications signal. The method further comprises transmitting each of the at least one uplink combined communications signal to a communications switch.

An additional embodiment of the disclosure relates to a communications distribution system. The communications distribution system comprises at least one communications switch and at least one gearbox connected between the at least one communications switch and a plurality of locations. The at least one gearbox comprises a plurality of server-side inputs, each configured to receive a respective uplink component communications signal from a respective location. The at least one gearbox further comprises at least one gearbox multiplexer configured to combine at least two of the uplink component communications signals into at least one respective uplink combined communications signal such that each uplink component communications signal is combined into only one of the at least one respective uplink combined communications signal. The at least one gearbox further comprises at least one switch-side output configured to transmit a respective uplink combined communications signal to the at least one communications switch. The at least one communications switch comprises at least one input configured to receive a respective uplink combined communications signal comprising a plurality of uplink component communications signals from the at least one gearbox. The at least one communications switch further comprises at least one switch demultiplexer configured to divide each of the at least one uplink combined communications signal into the respective plurality of uplink component communications signals.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE FIGURES

FIG. 1 is a view of a conventional quad small form-factor pluggable (QSFP) passive breakout cable assembly according to the prior art for connecting a plurality of devices to a QSFP port of a digital data switch;

FIG. 2 is a schematic diagram view of a conventional digital data switch connected to a plurality of servers via a conventional gearbox and a plurality of enhanced small form-factor pluggable (SFP+) connections;

FIG. 3 is a schematic diagram view of a simplified gearbox device having a plurality of inputs and outputs for muxing, demuxing, and synchronizing a plurality of uplink and downlink data streams of an exemplary embodiment;

FIG. 4 is a schematic diagram view of the gearbox device of FIG. 3 connected between a QSFP connection of a digital data switch and a plurality of SFP+ connections of a plurality of servers of an exemplary embodiment;

FIG. 5 is a graphical representation of conversion of a 20 gigabit (20 G) data stream into two unique 10 G data streams by the gearbox device of FIG. 4 of an embodiment;

FIG. 6 is a schematic diagram view of the operation of the gearbox device of FIG. 4 using the data stream conversion method of FIG. 5 of an embodiment;

FIG. 7A is a flowchart diagram of a method for distributing downlink communications signals using the gearbox device of FIGS. 3-6 of an embodiment;

FIG. 7B is a flowchart diagram of a method for distributing uplink communications signals using the gearbox device of FIGS. 3-6 of an embodiment; and

FIG. 8 is a schematic diagram view of a generalized representation of an exemplary computer system that can be included in or interface with any of the gearbox devices provided in the above described embodiments and/or their components described herein, wherein the exemplary computer system is adapted to execute instructions from an exemplary computer-readable medium.

### DETAILED DESCRIPTION

Various embodiments will be further clarified by the following examples. Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments of the disclosure relate to increasing radixes of digital data switches and communications switches, and related components and methods. In one embodiment, a gearbox distributes a plurality of high bandwidth digital data signals from a digital data switch to a plurality of devices. A gearbox can be a device or component that combines, divides, converts or otherwise modifies one or more communications or other signals for distribution. The digital data switch is configured to combine one or more groups of downlink component digital data signals into one or more respective downlink combined digital data signals, and transmit each combined digital data signal to the gearbox. Each downlink component digital data signal is combined into only one of the at least one respective downlink combined digital data signal. Thus, no individual component digital data signal is divided between multiple downlink combined digital data signals, thereby simplifying the process of combining the downlink component digital data signals and dividing the downlink combined digital data signals. The gearbox is then configured to divide each downlink digital data signal into its respective downlink component digital data signal, and transmit each downlink component digital data signal to a unique device or location. As a non-limiting example, each of a plurality of pairs of 10 gigabit (10 G) downlink component digital data signals is combined into a respective 20 G combined digital data signal. Each 20 G combined digital data signal comprises interleaved sections of each of the respective pair of 10 G downlink component digital data signals that can be easily synchronized to a clock signal. The gearbox can then divide each 20 G combined digital data signal into the pair of 10 G downlink component digital data signals and transmit each 10 G downlink component digital data signal to a unique device or location. In this manner, digital data switches can be designed employing embodiments disclosed herein to support increased numbers of devices and/or bandwidths within conventional form factors. One advantage of this arrangement is that the switch radix is doubled while maintaining backward compatibility with existing ports and connectors.

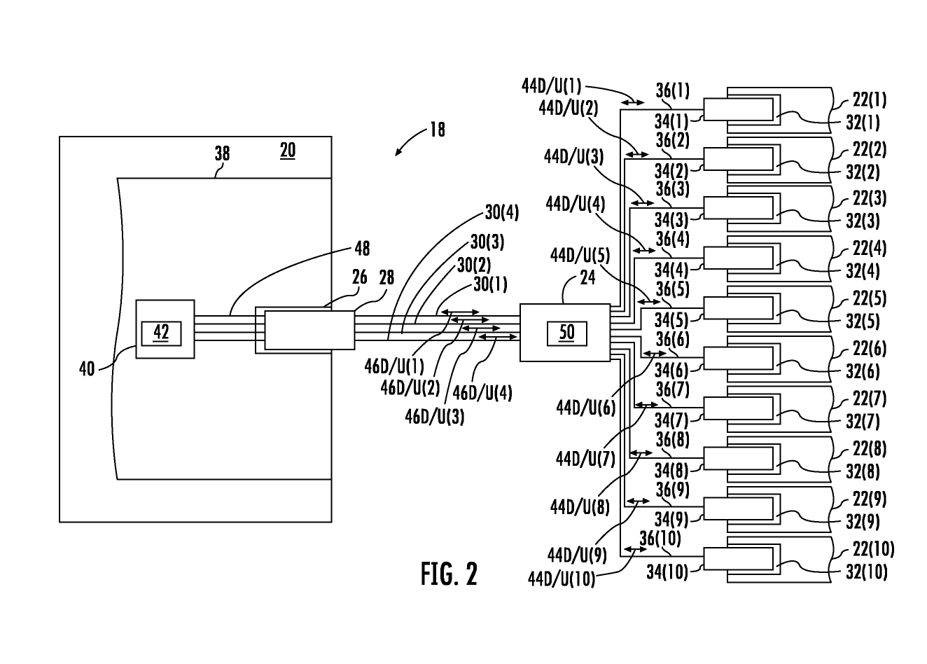

Before describing these and other embodiments in detail, an alternative solution is first described. In this regard, FIG. 2 illustrates an optical fiber-based system 18. The system 18 includes a switch 20, such as a digital data or communications switch, and at least one plurality of servers 22(1)-22(10) or other devices. A gearbox 24 is connected between each quad small-form factor (QSFP) port 26 of the switch 20 and the plurality of servers 22. It is noted that nomenclature of certain data links of the FIGS. are labeled as XXD/U(Y) or other similar nomenclature to represent bidirectional communication and may be discussed in the application such as XXD(Y) (e.g., referring to downstream link of the bidirectional communication) or XXU(Y) (e.g. referring to a upstream link of the bidirectional communication) as appropriate for the discussion. Each QSFP port 26 receives a QSFP connector 28 connected to the gearbox 24 via a high bandwidth communications medium. In this example, a QSFP connector 28 is part of an active connection that includes an optical transceiver and is connected to the gearbox 24 via four optical fiber pairs 30(1)-30(4). Alternatively, the QSFP connector 28 may be part of a passive connection, e.g., copper-based Ethernet. Each server 22 includes at least one SFP+ port 32 that receives an SFP+ connector 34. Each SFP+ connector 34 is connected to the gearbox 24 via a passive cable assembly 36, such as a copper-based cable assembly.

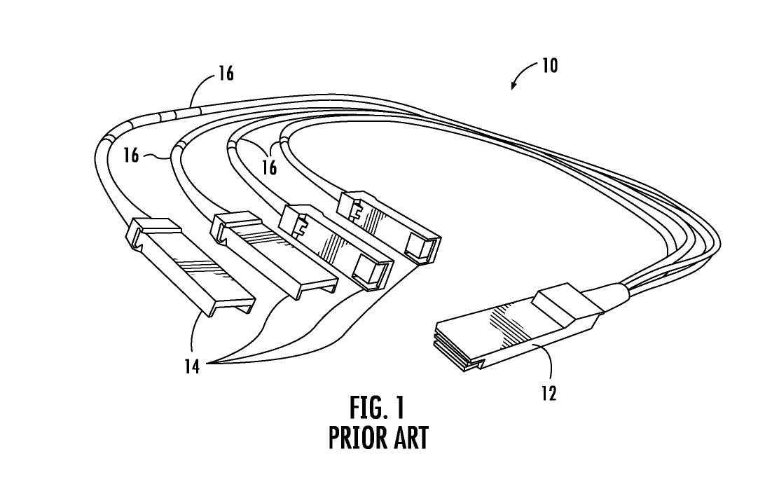

A switch motherboard 38 includes an application-specific integrated circuit (ASIC) 40, or other circuit that includes a distribution function 42. The distribution function 42 is configured to aggregate the ten (10) 10 G downlink signals 44D(1)-44D(10) into one 100 G stream across four (4) separate 25 G downlink signals 46D(1)-46D(4), which is another standardized bandwidth of the Ethernet standard. Because the 25 G Ethernet standard follows the 10 G Ethernet standard, which is used by the breakout cable assembly 10 of FIG. 1 for example, the alternative solution of FIG. 2 and other solutions use the 25 G standard. The ASIC 40 transfers the four (4) 25 G downlink signals 46D to the QSFP port 26 via internal circuitry 48, and from the QSFP connector 28 to the gearbox 24 via the four optical fiber pairs 30(1)-30(4), which support the increased bandwidth of the 25 G downlink signals 46D in this example. The gearbox 24 also includes a distribution function 50 that reconstructs the ten (10) 10 G downlink signals 44D from the four (4) 25 G downlink signals 46D. The gearbox 24 then distributes each 10 G downlink signal 44D to a server 22 or other device via a respective passive cable assembly 36. Each passive cable assembly 36 terminates in an SFP+ connector 34 connected to an SFP+ port 32 of a respective server 22.

A similar process is used by the gearbox 24 in FIG. 2 to aggregate ten (10) corresponding 10 G uplink signals 44U(1)-44U(10) received from the servers 22 into one 100 G stream across four (4) 25 G uplink signals 46U(1)-46U(4). The switch 20 then similarly reconstructs the ten (10) 10 G uplink signals 44U from the four (4) 25 G uplink signals 46U. Thus, this system 18 supports a higher number of devices than the conventional breakout cable assembly 10 of FIG. 1. However, this solution presents a number of challenges as well.

For example, converting ten (10) 10 G signals 44 into four (4) 25 G signals 46 requires complicated circuitry to be included in both the ASIC 40 of the switch 20 and in the gearbox 24. In the example of FIG. 2, at least two of the 10 G signals 44 must be divided across at least two 25 G signals 46, because each 25 G signal 46 can accommodate, at most, two complete 10 G signals 44. For example, in this embodiment, 10 G signals 44(1) and 44(2) are combined into 25 G signal 46(1), 10 G signals 44(3) and 44(4) are combined into 25 G signal 46(2), 10 G signals 44(5) and 44(6) are combined into 25 G signal 46(3), and 10 G signals 44(7) and 44(8) are combined into 25 G signal 46(4). Each 25 G signal 46 therefore has only 5 G of remaining bandwidth. Thus, the remaining 10 G signals 44(9) and 44(10) must be broken up and distributed across at least two of the 25 G signals 46 by an additional sub-process. Likewise, extracting each 10 G signal 44 from the four (4) 25 G signals 46 is also more complicated, because at least two of the 10 G signals 44 are distributed across more than one 25 G signal 46. Another drawback of this arrangement is that driving a 25 G signal 46 over copper Ethernet requires a large amount of power and has limited signal complexity capabilities in comparison to other technologies, such as optical fiber. Thus, for these and other reasons, the system 18 of FIG. 2 requires a complicated and involved process, which adds to the complexity and cost of the system 18.

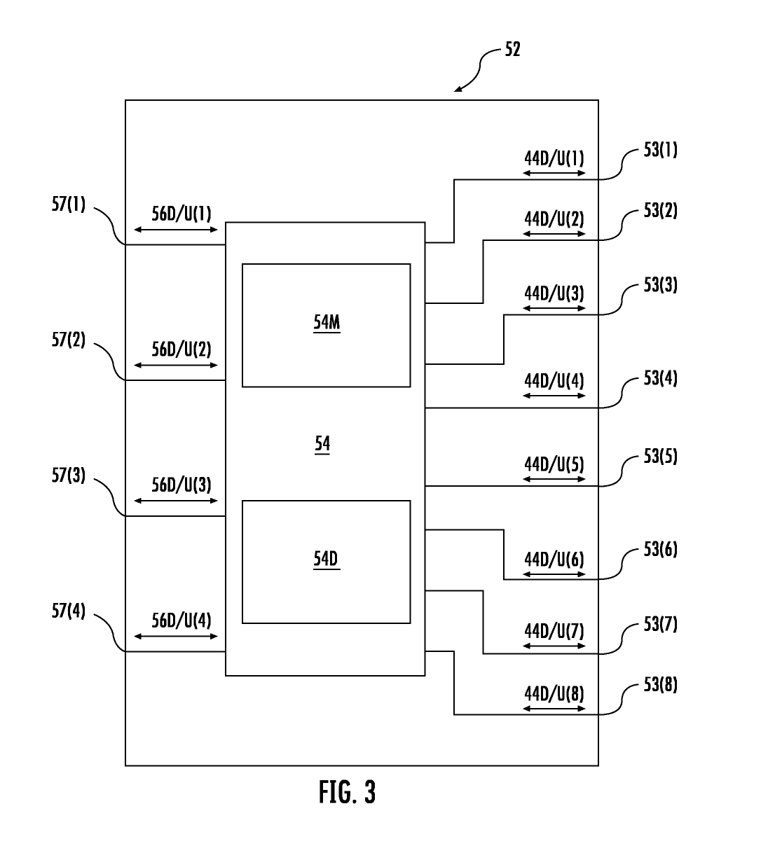

The complexity of the above arrangements can be reduced by employing exemplary embodiments described herein. In this regard, FIG. 3 discloses a gearbox 52 for increasing radixes of digital data switches and communications switches in a more efficient manner. The gearbox 52 receives uplink component communications signals 44U(1)-44U(8) via server-side input/output (I/O) connections 53(1)-53(8) and combines each pair of uplink component communications signals 44U(1)-44U(8), via a multiplexer/demultiplexer 54, into respective uplink combined communications signals 56(1)-(4). In this manner, each individual uplink component communications signals 44U is combined into only one respective uplink combined communications signal 56U, and no individual uplink component communications signals 44 is divided between more than one respective uplink combined communications signal 56U.

In FIG. 3 and subsequent figures, like features will be referred to by like reference numerals. For example, the 10 G signals 44U(1)-44U(8) in this embodiment are of the same type as the 10 G signals 44U(1)-44U(10) of FIG. 2. Each server-side input/output (I/O) connection 53 has one input and one output for receiving and transmitting respective 10 G uplink and downlink signals 44D/U(1)-(8) between a multiplexer/demultiplexer 54 of the gearbox 52 and a plurality of unique servers, devices, other local or remote network locations. It should be understood that, as used herein, the term “location” refers to a network node, device or other computing location, and does not necessarily require that different “locations” be located at different physical addresses or regions. In some embodiments, the multiplexer/demultiplexer 54 may be embodied in dedicated hardware, in software, or a combination of the two. In this embodiment, the multiplexer/demultiplexer 54 includes a multiplexer 54M and demultiplexer 54D as distinct components. In other embodiments, the multiplexer/demultiplexer 54 may be a single integrated component or function.

The gearbox 52 is likewise configured to receive and transmit respective 20 G uplink and downlink signals 56D/U(1)-(4) between the multiplexer/demultiplexer 54 of the gearbox 52 and one or more communications switches or other network device or location via a respective plurality of switch-side input/output (I/O) connections 57(1)-57(4), each having a respective input and output. In this regard, the terms “server-side” and “switch-side” are used herein for clarity and to distinguish input/output (I/O) connections 53(1)-53(8) from switch-side input/output (I/O) connections 57(1)-57(8), for example, and are not specifically limited to switch and/or server connections.

Unlike the distribution function 50 of FIG. 2, the multiplexer/demultiplexer 54 is operable to combine each pair of eight (8) 10 G uplink signals 44U(1)-44U(8) into one of four (4) 20 G uplink signals 56U(1)-56U(4) in this embodiment. This is counterintuitive because 20 G connections are less common than the more widely used and higher bandwidth 25 G connections described above with respect to FIG. 2. However, the advantages of using lower bandwidth 20 G uplink signals 56U rather than the higher bandwidth 25 G uplink signals 46U of FIG. 2 are considerable. For example, the process of combining each pair of 10 G uplink signals 44U into a single 20 G uplink signal 56U is significantly simpler and more efficient because less computing power and time is required to perform the simplified multiplexing/demultiplexing functions of the embodiment of FIG. 3.

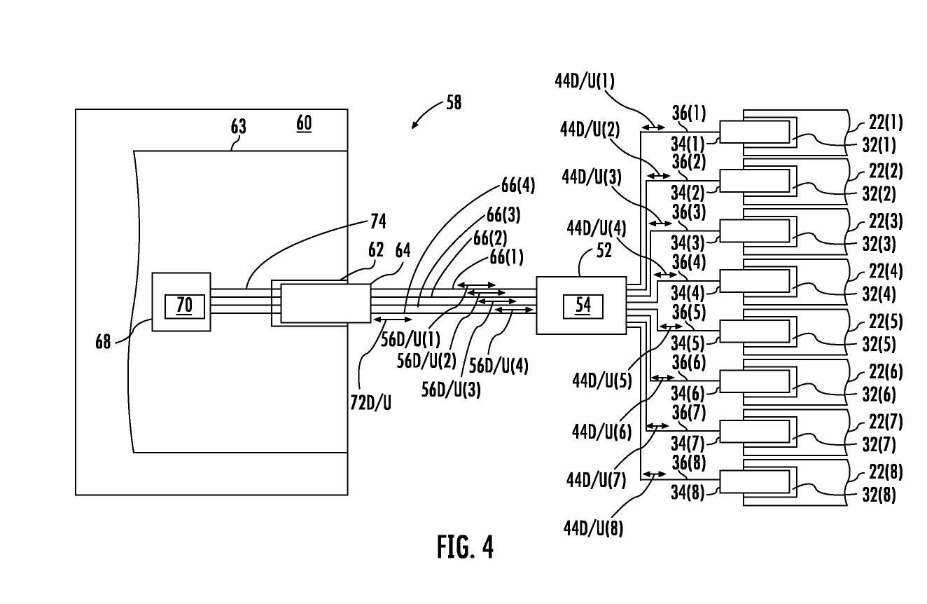

The multiplexer/demultiplexer 54 in the embodiment of FIG. 3 can also, for example, interleave sections of equal size for each 10 G uplink signal 44U of the pair into the 20 G uplink signal 56U, and may be synchronized to an integrated or separate clock signal (discussed in detail with respect to FIG. 4 below). Thus, the multiplexer/demultiplexer 54 of the improved gearbox 52 is significantly simpler and more efficient than the distribution function 50 of FIG. 2. Each 20 G uplink signal 56U includes a unique pair of 10 G uplink signals 44U in their entirety. For example, in this embodiment, 10 G uplink signals 44U(1) and 44U(2) are combined into 20 G uplink signal 56U(1), 10 G uplink signals 44U(3) and 44U(4) are combined into 20 G uplink signal 56U(2), 10 G uplink signals 44U(5) and 44U(6) are combined into 20 G uplink signal 56U(3), and 10 G uplink signals 44U(7) and 44U(8) are combined into 20 G uplink signal 56U(4).

One advantage of the gearbox 52 of FIG. 3 is that the gearbox 52 can be used to easily and efficiently increase a radix of a complementary communications switch. In this regard, FIG. 4 discloses a system 58 for increasing radixes of digital data switches and communications switches in a more efficient manner. System 58 includes a switch 60, a plurality of servers 22 or other devices, and the improved gearbox 52 of FIG. 3 connected between the switch 60 and servers 22. In this example, the gearbox 52 is not mounted, but the gearbox 52 could be mounted to an equipment rack (not shown), a server 22, or other hardware, as desired.

The improved gearbox 52 is connected between QSFP ports 62 connected to a switch motherboard 63 of the switch 60 and the SFP+ port 32 of each respective server 22. Each QSFP port 62 receives a QSFP transceiver 64 connected to the gearbox 52 via four optical fiber pairs 66(1)-62(4). It should be understood that other suitable media, such as copper-based media, may be used as a substitute for optical fiber in some embodiments, and vice versa. Each respective SFP+ port 32 receives an SFP+ connector 34. Each SFP+ connector 34 is connected to the gearbox 52 via a passive cable assembly 36, such as a copper-based cable. In this embodiment, each QSFP transceiver 64 is permanently attached to optical fiber pairs 66 (i.e., part of an active cable assembly that employs optical-to-electrical conversion and electrical-to-optical conversion), but the QSFP transceiver 64 and other connectors may be pluggable (i.e. passive) in other embodiments.

The switch motherboard 63 includes an ASIC 68 or other circuit that includes a multiplexer/demultiplexer 70, similar to multiplexer/demultiplexer 54 of gearbox 52. As with the gearbox multiplexer/demultiplexer 54, the switch multiplexer/demultiplexer 70 may be embodied in hardware, in software, or a combination of the two, and may also include a multiplexer and demultiplexer as separate components or as a single integrated component, for example. It should be noted that the terms “switch multiplexer/demultiplexer” and “gearbox multiplexer/demultiplexer” may be used herein for clarity and to distinguish embodiments of the multiplexer/demultiplexer 54 from embodiments of the multiplexer/demultiplexer 70, for example, and are not specifically limited to specific hardware and/or software.—for combining each of the four (4) unique pairs of the eight (8) 10 G downlink signals 44D(1)-44D(8) into one of four (4) 20 G downlink signals 56D(1)-56D(4). The multiplexer/demultiplexer 70 in the embodiment of FIG. 4 can interleave sections of equal size for each 10 G downlink signal 44D of the pair into the 20 G downlink signal 56D that is synchronized to a downlink clock signal 72D.

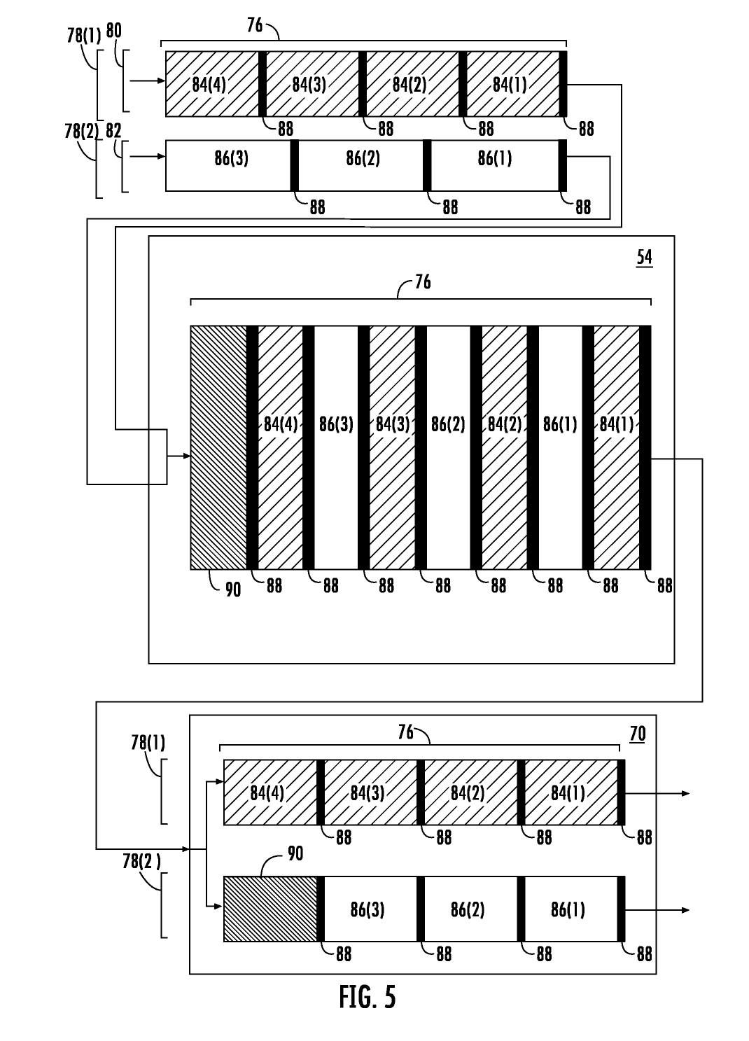

The multiplexer/demultiplexer 70 can combine these signals in a number of ways. In one example, the native data rate exiting the ASIC 68 is doubled. One advantage of this arrangement is that a pin count for the ASIC 68 remains constant, thereby allowing existing packaging to be used. Another solution is to double the pin count exiting the ASIC 68 and interpose a serializer/deserializer (SerDes) (not shown) between the ASIC 68 and a QSFP port 62. In this embodiment, the SerDes is disposed proximate to the QSFP port 62 to minimize a distance that each 20 G downlink signal 56D needs to travel on the switch motherboard 63. The operation of the multiplexer/demultiplexer 70 according to one non-limiting embodiment will be discussed in greater detail below with respect to FIG. 5.

Returning to FIG. 4, the ASIC 68 then transfers the four (4) 20 G downlink signals 56D, each including the embedded downlink clock signal 72D to the QSFP port 62 (or other I/O connection) via internal circuitry 74, and from the QSFP transceiver 64 to the gearbox 52 via downlink optical fibers 62D, which support the increased bandwidth of the 20 G downlink signals 56D. As discussed above, the gearbox 52 includes a multiplexer/demultiplexer 54 that reconstructs the eight (8) 10 G downlink signals 44D from the four (4) 20 G downlink signals 56D.

Thus, the system 58 does not require any 10 G downlink signal 44D to be distributed across more than one 20 G downlink signal 56D. As discussed above, this arrangement permits each 20 G downlink signal 56D to be composed of interleaved sections of equal size for each 10 G downlink signal 44D of the respective unique pair of 10 G downlink signals 44D. Accordingly, extracting each 10 G downlink signal 44D in this embodiment can be achieved by extracting the interleaved sections of each 10 G downlink signal 44D based on the downlink clock signal 72D.

The gearbox 52 then distributes each 10 G downlink signal 44D to a server 22 or other device via a respective passive cable assembly 36 in a manner similar to the arrangement of FIG. 2. Each passive cable assembly 36 terminates in an SFP+ connector 34 connected to an SFP+ port 32 of a respective server 22.

Thus, this system 58 retains the advantages of the system 18 of FIG. 2, notably the ability to support a significantly higher number of devices than the conventional breakout cable assembly 10 of FIG. 1. However, the system 58 achieves this result in a much more efficient and cost-effective manner. By reducing the complexity of the multiplexer/demultiplexer 70 of the ASIC 68 and the complementary multiplexer/demultiplexer 54 of the gearbox 52, the cost of the system 58 is significantly reduced over the cost of the system 18 of FIG. 2, while achieving a significantly higher switch density over the conventional breakout cable assembly 10 of FIG. 1. It should also be understood that the embodiments described herein are not limited to conversion between 10 G and 20 G bandwidths. For example, conversion between 20 G and 40 G bandwidths or other bandwidths could be performed in an analogous manner. It should also be understood that any number of signals may be combined into a single combined signal, provided that each component signal is combined into only one combined signal. For example, each group of N component signals having a bandwidth M could be combined into one combined signal having a bandwidth of (N×M), with each combined signal being divided back into the N component signals for distribution to one or more devices.

As discussed above, the simplified process of combining each unique pair of 10 G signals 44D/44U into a respective 20 G signal 56D/56U is discussed in greater detail in FIG. 5. In this regard, FIG. 5 illustrates an exemplary process of combining a pair of 10 G uplink signals 44U(1) and 44U(2) into a single 20 G uplink signal 56U(1), for example, by the multiplexer/demultiplexer 54 of the gearbox 52. The process of FIG. 5 further discloses extracting each of the pair of 10 G uplink signals 44U(1) and 44U(2) from the 20 G uplink signal 56U, for example, by the multiplexer/demultiplexer 70 of the ASIC 68.

In this regard, FIG. 5 illustrates a simplified diagram of a portion of each of the 10 G uplink signals 44U(1) and 44U(2), each having a same signal length 76. 10 G uplink signal 44U(1) has a bandwidth 78(1) of up to 10 G, and 10 G uplink signal 44U(2) likewise has a bandwidth 78(2) of up to 10 G. In this embodiment, as an illustrative example, an actual data rate 80 of uplink signal 44U(1) is higher than an actual data rate 82 of 10 G uplink signal 44U(2). In this example, for the purposes of illustration, the differences between data rates are significantly higher than in many real-world scenarios. For purposes of this simplified example, 10 G uplink signal 44U(1) has the actual data rate 80 sufficient to transmit four packets 84(1)-84(4) within the signal length 76. However, 10 G uplink signal 44U(2) is only able to transmit three packets 86(1)-86(3) within the same signal length 76 as a result of the lower actual data rate 82 of 10 G uplink signal 44U(2).

The multiplexer/demultiplexer 70 next combines these 10 G uplink signals 44U(1), 44U(2) into 20 G combined uplink signal 56D(1) (shown in FIG. 4) into an alternating sequence of equally sized packets 84, 86, with each packet 84, 86 preceded by a buffer segment 88 which embeds the uplink clock signal 72U into the 20 G combined uplink signal 56U(1). In this manner, the multiplexer/demultiplexer 70 of the ASIC 68 can easily split the 20 G combined uplink signal 56U(1) back into separate 10 G uplink signals 44U(1)-(2) by extracting the packets 84, 86 in an alternating manner.

However, it is necessary to account for the differing actual data rates 80, 82 when the packets 86 delivered from 10 G uplink signal 44U(2) lag behind the packets 84 delivered from 10 G uplink signal 44U(2), or vice versa. In this example, a fixed length packet 90, comprising null bits, for example, is inserted into the 10 G combined uplink signal 56U(1) so that the alternating arrangement of the packets 84, 86 is preserved. Thus, each series of packets 84, 86 of both 10 G uplink signals 44U(1) and 44U(2) can be interleaved into a combined 20 G uplink signal 56U(1) in a synchronized manner.

The 20 G uplink signal 56U(1) is then processed by the multiplexer/demultiplexer 70 of the ASIC 68, which, in this example, essentially reverses the process of the multiplexer/demultiplexer 54 of the gearbox 52. Each interleaved packet 84, 86 is identified by the multiplexer/demultiplexer 70 of the ASIC 68 using the corresponding buffer segments 88, for example. Each packet 84 is then lengthened such that the four packets 84 of 10 G downlink signal 44D(1) can be carried over the 10 G bandwidth 78(1) of 10 G downlink signal 44D(1) at their original signal length 76. Each packet 86 is likewise lengthened along with a packet 90 such that the three packets 86 of 10 G downlink signal 44D(2) can be carried over the 10 G bandwidth 78(2) of 10 G downlink signal 44D(2). In this example, when each 10 G downlink signal 44D(1) and 44D(2) is extracted from the 20 G downlink signal 56D(1) by the multiplexer/demultiplexer 54 of the gearbox 52, the packet 90 containing null bits can be retained, where it may be ignored by the switch 60. In another embodiment, packet 90 can be removed by the multiplexer/demultiplexer 70 of the ASIC 68 by an additional process before transmitting 10 G uplink signals 44U(1) and 44U(2) at their original actual data rates 80, 82.

A similar process may be performed for the other pairs of 10 G uplink signals 44U (e.g., 44U(3)/44U(4), 44U(5)/44U(6), 44U(7)/44U(8)). Likewise, a similar, reversed process may be performed for corresponding pairs of 10 G downlink signals 44D as well. It should be understood, however, that synchronization of the alternating packets 84, 86 of the 10 G downlink signals 44D is not required in this example because, unlike the 10 G uplink signals 44U, all the 10 G downlink signals 44D originate from the same switch 60 and are thus already synchronized to a single clock signal 72D. It also should be understood that, although the above processes are symmetrical, and result in the same 10 G signals 44D/U being employed on both the switch 60 side and the gearbox 52 side, the above embodiments are not limited thereto, and that a number of variations, omissions or additions to the disclosed embodiments are contemplated.

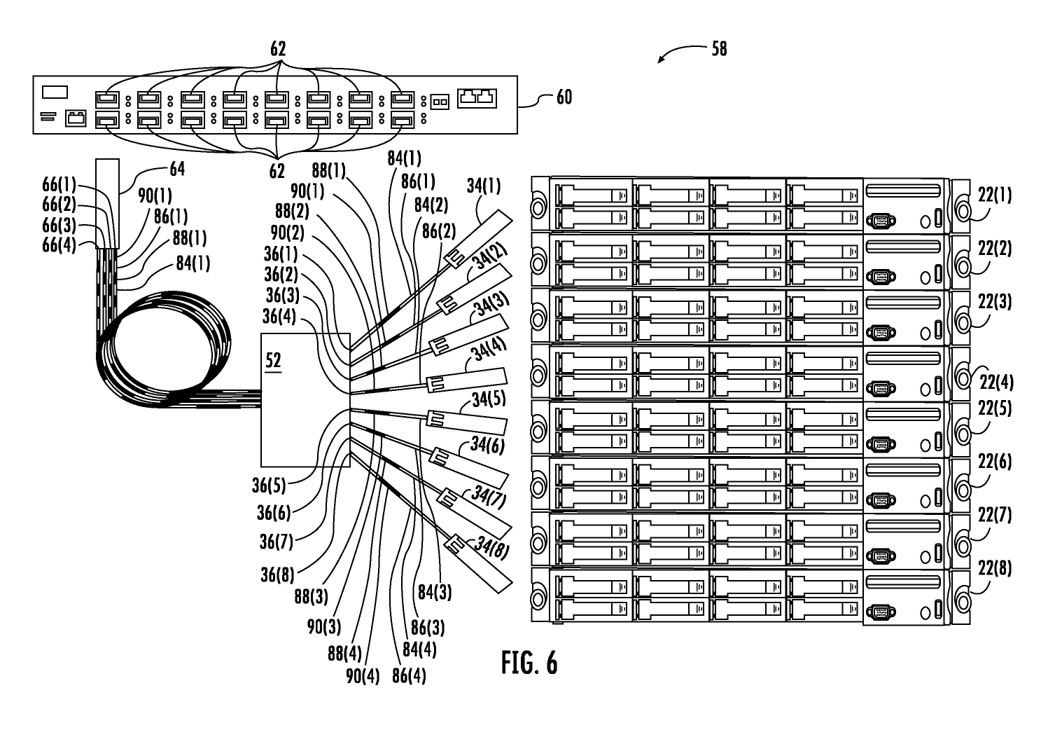

Application of the above process of FIG. 5 to the system 58 of FIG. 4 is illustrated in FIG. 6. As in FIG. 4, the switch 60 and servers 22 are connected via the gearbox 52. The gearbox 52 is connected to a QSFP port 62 of the switch 60 via four (4) 20 G optical fiber pairs 66(1)-62(4) connected to a QSFP transceiver 64. The gearbox 52 is likewise connected to an SFP+ port 32 (shown in FIG. 4) of eight (8) respective servers 22 via a 10 G passive cable assembly 36 connected to a passive SFP+ connector 34.

Focusing now on 20 G optical fiber pair 66(1), interleaved data segments 84, 86 and buffer segments 88, 90 of 20 G downlink signal 56D, arranged according to the process of FIG. 5, are illustrated. Turning now to 10 G passive cable assemblies 36(1) and 36(2), it can also be seen that the gearbox 52 extracts data segments 84 and buffer segments 88 to reconstitute and transmit 10 G downlink signal 44D(1) on 10 G passive cable assembly 36(1). The gearbox 52 likewise extracts data segments 86 and buffer segments 90 to reconstitute and transmit 10 G downlink signal 44D(2) on 10 G passive cable assembly 36(2). As with FIG. 5, similar processes are performed for all downlink and uplink signals 44D/U, 56D/U.

In this manner, each QSFP port 62 of the switch 60 is capable of supporting up to eight (8) 10 G server 22 connections. In this example, the switch 60 includes sixteen (16) QSFP ports 62. Thus, the switch 60 in this example can support as many as one hundred twenty eight (124) individual servers 22, or a total of one thousand two hundred eighty (1280) gigabits of bandwidth. Using the conventional breakout cable assembly 10 of FIG. 1, the same switch 60 could only support sixty-four (64) servers 22, i.e., six hundred forty (640) gigabits of bandwidth.

In another embodiment, a 1U switch (not shown) may include as many as thirty six (36) QSFP ports 62 within a standard 1U rack space. Thus, a 1U switch having thirty-six (36) QSFP ports 62 can support up to two hundred eighty-eight (288) individual servers 22, or a total of two thousand eight hundred eighty (2880) gigabits of bandwidth. Using the conventional breakout cable assembly 10 of FIG. 1, the same switch 60 could only support one hundred forty-four (144) servers 22, i.e., one thousand four hundred forty (1440) gigabits of bandwidth.

In an alternative embodiment, a 3U switch (not shown) may include as many as one hundred eight (108) QSFP ports 62 within a standard 3U rack space. Thus, a 1U switch having one hundred eight (108) QSFP ports 62 can support up to eight hundred sixty-four (864) individual servers 22, or a total of eight thousand six hundred forty (8640) gigabits of bandwidth. Using the conventional breakout cable assembly 10 of FIG. 1, the same switch 60 could only support four hundred thirty-two (432) servers 22, i.e., four thousand three hundred twenty (4320) gigabits of bandwidth.

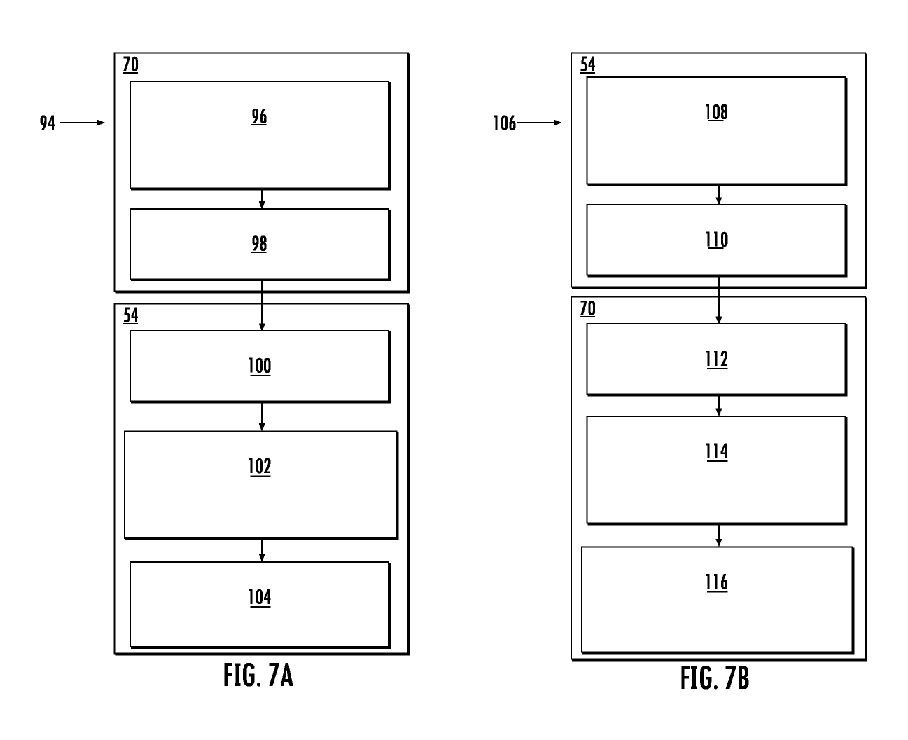

The above described systems can employ a number of processes to distribute communications signals. In this regard, an exemplary process for distributing communications signals is described with respect to FIG. 7A and 6B. FIG. 7A discloses a process 94 for distributing downlink communications signals, such as the 10 G downlink signals 44D of FIG. 4. In the process of FIG. 7A, each unique pair of downlink component communications signals is combined, for example, by the multiplexer/demultiplexer 70 of the ASIC 68 (not shown), into a downlink combined communications signal, such that each downlink component communications signal is combined into only one respective downlink combined communications signal (block 96). Next, each downlink combined communications signal is transmitted to a gearbox, such as the gearbox 52 of FIG. 4 (block 98). The gearbox receives the downlink combined communications signals (block 100) and divides each downlink combined communications signal into the respective pair of downlink component communications signals (block 102), for example, using the multiplexer/demultiplexer 54 of the gearbox 52 (not shown). Each downlink component communications signal is then transmitted to a unique device, such as a server 22 of FIG. 4 (block 104), or other unique location.

FIG. 7B discloses a complementary process 106 for distributing uplink communications signals, such as the 10 G uplink signals 44U of FIG. 4. In the process of FIG. 7B, each unique pair of uplink component communications signals is combined, for example, by the multiplexer/demultiplexer 54 of the gearbox 52, into an uplink combined communications signal, such that each uplink component communications signal is combined into only one respective uplink combined communications signal (block 108). Next, each uplink combined communications signal is transmitted to a switch, such as the switch 60 of FIG. 4 (block 110). The switch receives the uplink combined communications signals (block 112) and divides each uplink combined communications signal into the respective pair of uplink component communications signals (block 114), for example, using the multiplexer/demultiplexer 70 of ASIC 68. Each uplink component communications signal may then be utilized by the switch (block 116).

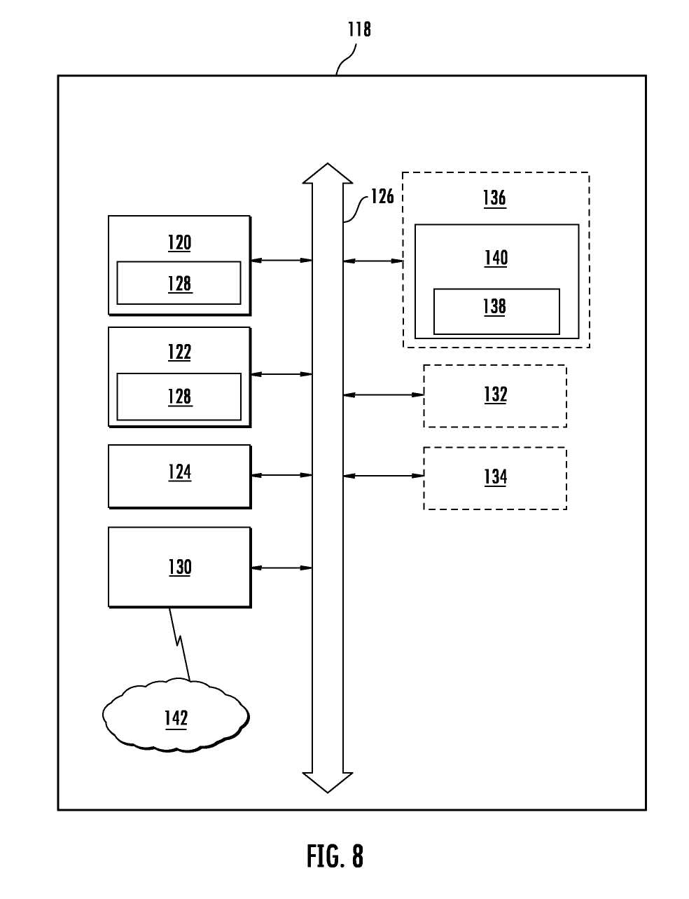

Any of the switch devices or other components disclosed herein, such as the switch 60 of FIG. 4, can include a computer system. In this regard, FIG. 8 is a schematic diagram representation of additional detail regarding an exemplary form of an exemplary computer system 118 that is adapted to execute instructions. In this regard, the computer system 118 includes a set of instructions for causing switch device component(s) to provide its designed functionality. The switch device component(s) may be connected (e.g., networked) to other machines in a LAN, an intranet, an extranet, or the Internet. The switch device component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The switch device component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer. The exemplary computer system 118 in this embodiment includes a processing device or processor 120, a main memory 122 (e.g., read-only memory (ROM), flash memory, dynamic random access memory (DRAM) such as synchronous DRAM (SDRAM), etc.), and a static memory 124 (e.g., flash memory, static random access memory (SRAM), etc.), which may communicate with each other via a data bus 126. Alternatively, the processing device 120 may be connected to the main memory 122 and/or static memory 124 directly or via some other connectivity means. The processing device 120 may be a controller, and the main memory 122 or static memory 124 may be any type of memory, each of which can be included in the switch 60 and/or gearbox 52 of FIG. 4, for example.

The processing device 120 represents one or more general-purpose processing devices such as a microprocessor, central processing unit, or the like. More particularly, the processing device 120 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 120 is configured to execute processing logic in instructions 128 (located in the processing device 120 and/or the main memory 122) for performing the operations and steps discussed herein.

The computer system 118 may further include a network interface device 130. The computer system 118 also may or may not include an input 132 to receive input and selections to be communicated to the computer system 118 when executing the instructions 128. The computer system 118 also may or may not include an output 134, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 118 may or may not include a data storage device 136 that includes instructions 138 stored in a computer-readable medium 140. The instructions 138 may also reside, completely or at least partially, within the main memory 122 and/or within the processing device 120 during execution thereof by the computer system 118, the main memory 122 and the processing device 120 also constituting the computer-readable medium 140. The instructions 128, 138 may further be transmitted or received over a network 142 via the network interface device 130.

While the computer-readable medium 140 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical and magnetic medium, and carrier wave signals.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an ASIC, a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the specification should be construed to include everything within the scope of the appended claims and their equivalents.

We claim:

1. A gearbox for a communications system comprising:
a plurality of server-side inputs each configured to receive a respective uplink component communications signal from a respective location;
at least one multiplexer configured to combine at least two of the uplink component communications signals into at least one respective uplink combined communications signal such that each uplink component communications signal is combined into only one of the at least one respective uplink combined communications signal; and
at least one switch-side output configured to transmit a respective uplink combined communications signal to a communications switch.

2. The gearbox of claim 1, further comprising:
at least one switch-side input corresponding to the at least one switch-side output, each switch-side input configured to receive at least one downlink combined communications signal each comprising a plurality of downlink component digital communications from the communications switch; and
a plurality of server-side outputs corresponding to the plurality of server-side inputs, each server-side output configured to transmit a respective downlink component communications signal to the respective location associated with the respective server-side output.

3. The gearbox of claim 1, wherein each switch-side output corresponds to a respective unique pair of switch-side inputs;
each respective pair of switch-side inputs is configured to receive a respective pair of uplink component communications signals consisting of two (2) ten gigabit (10 G) signals; and
each switch-side output is configured to transmit a respective uplink combined communications signal consisting of a twenty gigabit (20 G) signal.

4. The gearbox of claim 3, further comprising at least four (4) switch-side outputs and at least eight (8) switch-side inputs.

5. The gearbox of claim 4, further comprising at least one quad small form-factor pluggable (QSFP) port, each corresponding to a group of four (4) switch-side outputs.

6. A communications switch comprising:
at least one input configured to receive a respective uplink combined communications signal comprising a plurality of uplink component communications signals from a gearbox, each uplink component communications signal corresponding to a location; and
at least one demultiplexer configured to divide each uplink combined communications signal into the respective plurality of uplink component communications signals.

7. The communications switch of claim 6, further comprising:
at least one output corresponding to the at least one input configured to transmit a respective downlink combined communications signal comprising a plurality of downlink component communications signals to the gearbox such that each downlink component communications signal is combined into only one of the at least one downlink combined communications signal; and
wherein the multiplexer is further configured to combine each plurality of downlink component communications signals into the respective downlink combined communications signal.

8. The communications switch of claim 6, wherein each uplink combined communications signal corresponds to a respective unique pair of uplink component communications signals;
each unique pair of uplink component communications signals consists of two (2) ten gigabit (10 G) signals; and
each uplink combined communications signal consists of a twenty gigabit (20 G) signal.

9. The communications switch of claim 8, further comprising at least four (4) inputs.

10. The communications switch of claim 9, further comprising at least one quad small form-factor pluggable (QSFP) port, each corresponding to a group of four (4) inputs.

11. The communications switch of claim 6, further having a 1U form factor and at least seventy-three (73) inputs, the communications switch being further configured to receive at least seventy-three (73) 20 G uplink combined communications signals, thereby receiving at least one hundred forty-six (146) 10 G uplink component communications signals from at least one hundred forty-six (146) respective locations.

12. The communications switch of claim 6, further having a 3U form factor and at least two hundred seventeen (217) inputs, the switch being further configured to provide at least two hundred seventeen (217) 20 G uplink combined communications signals, thereby providing at least four hundred thirty-four (434) 10 G uplink component communications signals to at least four hundred thirty-four (434) respective locations.

13. A method of transferring communications signals, comprising:
receiving, at a gearbox, a plurality of uplink component communications signals;
combining, at the gearbox, at least two of the uplink component communications signals into at least one respective uplink combined communications signal such that each uplink component communications signal is combined into only one of the at least one respective uplink combined communications signal; and
transmitting each of the at least one uplink combined communications signal to a communications switch.

14. The method of claim 13, further comprising:
receiving, at the communications switch, the at least one uplink combined communications signal; and
dividing each of the at least one uplink combined communications signal into the respective plurality of uplink component communications signals.

15. The method of claim 13, further comprising:
combining, at the communications switch, at least two downlink component communications signals into at least one respective downlink combined communications signal; and
transmitting each of the at least one downlink combined communications signal to the gearbox.

16. The method of claim 15, further comprising:
receiving, at the gearbox, the at least one downlink combined communications signal from the gearbox;
dividing each of the at least one downlink combined communications signal into the respective plurality of downlink component communications signals; and
transmitting each of the plurality of downlink component communications signals to a location.

17. The method of claim 13, wherein each of the at least one uplink combined communications signal is a twenty gigabit (20 G) signal corresponding to two (2) uplink component communications signals consisting of two (2) 10 G signals.

18. A communications distribution system comprising:
at least one communications switch; and
at least one gearbox connected between the at least one communications switch and a plurality of locations;
wherein the at least one gearbox comprises:
a plurality of server-side inputs, each configured to receive a respective uplink component communications signal from a respective location;
at least one gearbox multiplexer configured to combine at least two of the uplink component communications signals into at least one respective uplink combined communications signal such that each uplink component communications signal is combined into only one of the at least one respective uplink combined communications signal; and
at least one switch-side output configured to transmit a respective uplink combined communications signal to the at least one communications switch; and
wherein the at least one communications switch comprises:
at least one input configured to receive a respective uplink combined communications signal comprising a plurality of uplink component communications signals from the at least one gearbox; and
at least one switch demultiplexer configured to divide each of the at least one uplink combined communications signal into the respective plurality of uplink component communications signals.

19. The communications distribution system of claim 18, wherein:
the at least one communications switch further comprises:
at least one switch multiplexer configured to combine at least two of a plurality of downlink component communications signals corresponding to the plurality of uplink component communications signals into at least one respective downlink combined communications signal such that each downlink component communications signal is combined into only one of the at least one respective downlink combined communications signal;
at least one output corresponding to the at least one input, each configured to transmit a respective downlink combined communications signal to the at least one communications switch; and
the at least one gearbox father comprises:
at least one switch-side input configured to receive a respective downlink combined communications signal comprising a plurality of downlink component communications signals from the at least one gearbox; and
at least one switch demultiplexer configured to divide each of the at least one downlink combined communications signal into the respective plurality of downlink component communications signals.

20. The communications distribution system of claim 19, wherein:
each of the at least one respective downlink combined communications signal is a twenty gigabit (20 G) signal;
each of the at least one respective uplink combined communications signal is a twenty gigabit (20 G) signal;
each of the at least one plurality of downlink component communications signals corresponding to each of the at least one respective downlink combined communications signal consists of two (2) 10 G signals; and
each of the at least one plurality of uplink component communications signals corresponding to each of the at least one respective uplink combined communications signal consists of two (2) 10 G signals.
